(19) United States
(12) Patent Application Publication
(10) Pub. No.: US 2016/0313973 A1
(43) Pub. Date: Oct. 27, 2016

(54) DISPLAY DEVICE, CONTROL METHOD FOR DISPLAY DEVICE, AND COMPUTER PROGRAM

(71) Applicant: SEIKO EPSON CORPORATION, Tokyo (JP)

(72) Inventor: Kenro YAJIMA, Matsumoto-shi (JP)

(73) Assignee: SEIKO EPSON CORPORATION, Tokyo (JP)

(21) Appl. No.: 15/132,765

(22) Filed: Apr. 19, 2016

(30) Foreign Application Priority Data
Apr. 24, 2015 (JP) 2015-089327

(51) Int. Cl. G06F 3/16; G06F 3/01; G02B 27/01; H04R 1/02; H04R 29/00

(52) U.S. Cl. CPC G06F 3/167; H04R 1/023; H04R 29/004; G02B 27/0172; G06F 3/012; H04R 2430/20; H04R 2430/01; G02B 2027/014

(57) ABSTRACT

An HMD includes an image display section that causes the user to visually recognize an image and transmits an outside scene and a earphone that output sound. The HMD executes, with an AR control section, sound output processing for causing the earphone to output sound corresponding to an image displayed by the image display section and output control processing including sound processing for the sound output by the earphone or processing for the image displayed by the image display section, the output control processing changing the audibility of the sound output by the earphone.

### BACKGROUND

1. Technical Field

The present invention relates to a display device, a control method for the display device, and a computer program.

2. Related Art

As an HMD mounted on the head of a viewer, there has been known an HMD that outputs a video and sound (see, for example, JP-A-2002-171460 (Patent Literature 1)). The HMD described in Patent Literature 1 outputs a video segmented from a video in a range of 360° surrounding a viewer and an acoustic signal obtained by converting localization of an acoustic signal of sound in the range of 360° surrounding the viewer.

When the HMD outputs an image such as a video and sound as described in Patent Literature 1, the audibility of sound output by the device is sometimes deteriorated by the influence of environmental sound on the outside unrelated to the video and the sound. It is conceivable to block the environmental sound on the outside in order to eliminate the influence. However, there is a concern about deterioration in convenience when the environmental sound is not heard.

### SUMMARY

An advantage of some aspects of the invention is to make it possible to prevent deterioration in audibility due to the influence of, for example, environmental sound on the outside without spoiling convenience in a device that outputs an image and sound.

An aspect of the invention is directed to a display device mounted on the head of a user, the display device including: a display section configured to display an image; a sound output section configured to output sound; and a processing section configured to execute sound output processing for causing the sound output section to output sound and output control processing including sound processing for the sound output by the sound output section or processing for the image displayed by the display section, the output control processing changing the audibility of the sound output by the sound output section.

According to the aspect of the invention, in the display device that displays an image and outputs sound corresponding to the image, by changing the audibility of the output sound, it is possible to improve the audibility without blocking factors of deterioration in the audibility such as environmental sound on the outside. Consequently, it is possible to achieve improvement of a visual effect and an audio effect without spoiling convenience.

In the display device according to the aspect of the invention, in the sound output processing, the processing section may cause the sound output section to output sound corresponding to the image displayed by the display section.

According to the aspect of the invention with this configuration, when outputting the sound corresponding to the displayed image, it is possible to achieve more conspicuous improvement of the visual effect and the audio effect by changing the audibility of the sound.

In the display device according to the aspect, the display device may further include a motion detecting section configured to detect at least any one of the position, the movement, and the direction of the head of the user, and the processing section may execute the output control processing on the basis of a result of the detection of the motion detecting section.

According to the aspect of the invention with this configuration, it is possible to improve the audibility of the sound output by the display device according to the position and the movement of the head of the user. Therefore, it is possible to achieve further improvement of the audio effect.

In the display device according to the aspect of the invention, the display device may further include a movement sensor configured to detect the movement of the head of the user, and the motion detecting section may calculate at least one of the position, the movement, and the direction of the head of the user on the basis of a detection value of the movement sensor.

According to the aspect of the invention with this configuration, it is possible to easily detect the position, the movement, and the direction of the head of the user.

In the display device according to the aspect of the invention, the processing section may perform sound specifying processing for specifying external sound and the position of a sound source of the external sound and execute the output control processing on the basis of the specified external sound or the specified position of the sound source.

According to the aspect of the invention with this configuration, it is possible to improve the audibility of the sound output by the display device by performing the processing on the basis of the position of the sound source of the output emitted from the outside.

In the display device according to the aspect of the invention, the display device may further include a microphone configured to collect and detect the external sound, and the processing section may execute the sound specifying processing on the basis of sound detected from a gazing direction of the user by the microphone and the detection result of the motion detecting section and specify the external sound and the position of the sound source that emits the external sound.

According to the aspect of the invention with this configuration, it is possible to easily detect the external sound and the position of the sound source of the external sound.

In the display device according to the aspect of the invention, in the output control processing, the processing section may cause the sound output section to output sound based on the external sound detected by the microphone.

According to the aspect of the invention with this configuration, it is possible to prevent deterioration in the audibility of the sound output by the display device because of the influence of the external sound and perform processing based on the external sound.

In the display device according to the aspect of the invention, the processing section may calculate relative positions of the position of the head of the user detected by the motion detecting section and the position of the sound source specified by the sound specifying section and execute the output control processing on the basis of the calculated relative positions.

According to the aspect of the invention with this configuration, it is possible to surely improve the audibility of the sound output by the display device according to the position of the head of the user and the position of the sound source.

In the display device according to the aspect of the invention, the processing section may calculate relative positions of the position of the sound source specified by the sound specifying processing and each of the eyes and the ears of the user in addition to the relative positions of the position of the head of the user and the position of the sound source.

According to the aspect of the invention with this configuration, it is possible to more surely improve the audibility of the sound output by the display device.

In the display device according to the aspect of the invention, the processing section may generate auditory sense information related to auditory sensation of the user on the basis of the relative positions of the position of the head of the user and the position of the sound source, execute the output control processing on the basis of the auditory sense information, and update the auditory sense information on the basis of the movement of the head of the user detected by the motion detecting section.

According to the aspect of the invention with this configuration, it is possible to perform processing that appropriately reflects the relative positions of the head of the user and the sound source.

In the display device according to the aspect of the invention, in the output control processing, the processing section may perform processing for the image displayed by the display section to change the visibility of the user in viewing a direction corresponding to the position of the sound source.

According to the aspect of the invention with this configuration, it is possible to effectively give influence to the auditory sense by changing, with the visual effect of the displayed image, the visibility of the user in viewing the direction in which the sound source is located.

In the display device according to the aspect of the invention, the display device may further include a visual-line detecting section configured to detect a visual line direction of the user, and the processing section may specify a gazing direction of the user from a result the detection of the visual-line detecting section and execute the output control processing according to the specified direction.

According to the aspect of the invention with this configuration, it is possible to detect the gazing direction of the user and further improve the visual effect and the audio effect.

In the display device according to the aspect of the invention, in the output control processing, the processing section may display the image over a target object located in the gazing direction of the user.

According to the aspect of the invention with this configuration, it is possible to obtain an original visual effect.

Another aspect of the invention is directed to a display device mounted on the head of a user, the display device including: a display section configured to display an image; and a processing section configured to detect a gazing direction of the user or a target object gazed by the user and cause the display section to perform display for improving visibility in the detected gazing direction or the visibility of the detected target object.

According to the aspect of the invention, in the display device that displays an image, by improving the visibility in the gazing direction of the user to thereby call more strong attention to the gazing direction, it is possible to expect an effect of improving the audibility of sound heard from the gazing direction. Therefore, it is possible to improve, making use of a so-called cocktail party effect, the audibility of sound that the user desires to hear.

Still another aspect of the invention is directed to a display device mounted on the head of a user, the display device including: a display section configured to display an image; a sound output section configured to output sound; and a processing section configured to execute sound output processing for causing the sound output section to output sound corresponding to the image displayed by the display section and output control processing including sound processing for the sound output by the sound output section or processing for the image displayed by the display section, the output control processing changing the audibility of the sound output by the sound output section. The processing section detects, in the output control processing, a gazing direction of the user or a target object gazed by the user, selects sound reaching from the detected gazing direction or a direction of the detected target object, and performs acoustic processing for improving the audibility of the selected sound.

According to the aspect of the invention, in the display device that displays an image and outputs sound corresponding to the image, by changing the audibility of the output sound, it is possible to improve the audibility without blocking factors of deterioration in the audibility such as environmental sound on the outside. Consequently, it is possible to achieve improvement of a visual effect and an audio effect without spoiling convenience.

Yet another aspect of the invention is directed to a display device mounted on the head of a user, the display device including: a display section configured to display an image; a sound output section configured to output sound; a microphone configured to collect and detect external sound; and a processing section configured to execute sound output processing for causing the sound output section to output sound corresponding to the image displayed by the display section and output control processing including sound processing for the sound output by the sound output section or processing for the image displayed by the display section, the output control processing changing the audibility of the sound output by the sound output section. The processing section executes translation processing for recognizing the sound collected by the microphone as a language and translating the sound and translated voice output processing for causing the sound output section to output voice after the translation and causes, in performing the translated voice output processing, the display section to display an image corresponding to the voice after the translation.

According to the aspect of the invention, in the display device that displays an image and outputs sound corresponding to the image, it is possible to collect and translate sound, output voice after the translation, and prevent a situation in which it is hard to identify the voice after the translation because of visual information. Therefore, it is possible to improve the audibility of the voice after the translation.

Still yet another aspect of the invention is directed to a control method for a display device, the control method including: controlling a display device worn on the head of a user and including a display section configured to display an image and a sound output section configured to output sound: causing the sound output section to output sound; and executing output control processing including sound processing for the sound output by the sound output section or processing for the image displayed by the display section, the output control processing changing the audibility of the sound output by the sound output section.

According to the aspect of the invention, it is possible to change the audibility of sound output by the display device and improve the audibility without blocking factors of deterioration in the audibility such as environmental sound on the outside. Consequently, it is possible to achieve improvement of a visual effect and an audio effect without spoiling convenience.

Further another aspect of the invention is directed to a computer program executable by a computer that controls a display device worn on the head of a user and including a display section configured to display an image and a sound output section configured to output sound, the computer program causing the computer to function as a processing section configured to execute sound output processing for causing the sound output section to output sound and output control processing including sound processing for the sound output by the sound output section or processing for the image displayed by the display section, the output control processing changing the audibility of the sound output by the sound output section.

According to the aspect of the invention, it is possible to change the audibility of sound output by the display device and improve the audibility without blocking factors of deterioration in the audibility such as environmental sound on the outside. Consequently, it is possible to achieve improvement of a visual effect and an audio effect without spoiling convenience.

### BRIEF DESCRIPTION OF THE DRAWINGS

The invention will be described with reference to the accompanying drawings, wherein like numbers reference like elements.

FIG. 1 is an explanatory diagram showing the exterior configuration of an HMD according to an embodiment of the invention.

FIGS. 2A and 2B are diagrams showing the main part configuration of an image display section.

FIG. 3 is a functional block diagram of sections configuring the HMD.

FIG. 4 is a flowchart for explaining the operation of the HMD.

FIG. 5 is a flowchart for explaining the operation of the HMD.

FIG. 6 is a flowchart for explaining the operation of the HMD.

FIG. 7 is a flowchart for explaining the operation of the HMD.

FIG. 8 is a flowchart for explaining the operation of the HMD.

FIG. 9 is a flowchart for explaining the operation of the HMD.

### DESCRIPTION OF EXEMPLARY EMBODIMENTS

An embodiment of the invention is explained below with reference to the drawings.

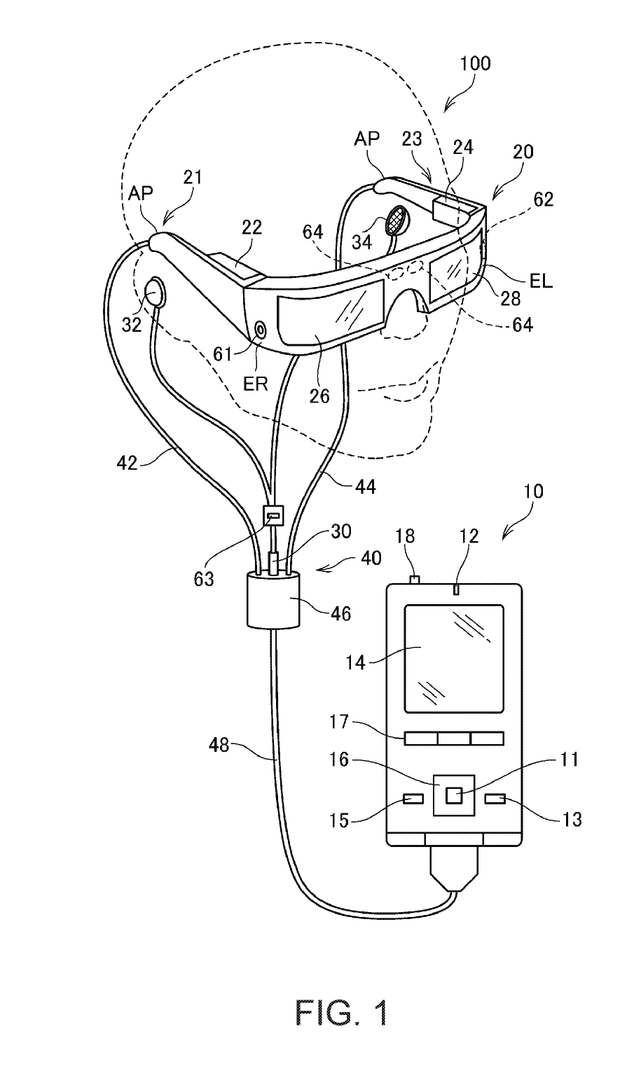

FIG. 1 is an explanatory diagram showing the exterior configuration of an HMD 100 according to an embodiment applied with the invention. The HMD 100 is a display device mounted on a head by a user (a viewer) and is called head mounted display (head-mounted display device) as well. The HMD 100 in this embodiment is an optically transmissive display device with which the user can visually recognize a virtual image and at the same time directly visually recognize an outside scene. Note that, in this specification, the virtual image visually recognized by the user with the HMD 100 is referred to as “display image” for convenience. Emitting image light generated on the basis of image data is referred to as “display an image” as well.

The HMD 100 includes an image display section 20 (a display section) that causes the user to visually recognize the virtual image in a state in which the image display section 20 is worn on the head of the user and a control device 10 that controls the image display section 20. The control device 10 also functions as a controller with which the user operates the HMD 100.

The image display section 20 is a wearing body worn on the head of the user. In this embodiment, the image display section 20 has an eyeglass shape. The image display section 20 includes a right holding section 21, a right display driving section 22, a left holding section 23, a left display driving section 24, a right optical-image display section 26, a left optical-image display section 28, a right camera 61, a left camera 62, and a microphone 63. The right optical-image display section 26 and the left optical-image display section 28 are disposed to be respectively located in front of the right eye and in front of the left eye of the user when the user wears the image display section 20. One end of the right optical-image display section 26 and one end of the left optical-image display section 28 are connected to each other in a position corresponding to the middle of the forehead of the user when the user wears the image display section 20.

The right holding section 21 is a member provided to extend from an end portion ER, which is the other end of the right optical-image display section 26, to a position corresponding to the temporal region of the user when the user wears the image display section 20. Similarly, the left holding section 23 is a member provided to extend from an end portion EL, which is the other end of the left optical-image display section 28, to a position corresponding to the temporal region of the user when the user wears the image display section 20. The right holding section 21 and the left holding section 23 hold the image display section 20 on the head of the user like temples of eyeglasses.

The right display driving section 22 and the left display driving section 24 are disposed on sides opposed to the head of the user when the user wears the image display section 20. Note that the right display driving section 22 and the left display driving section 24 are collectively simply referred to as “display driving sections” as well and the right optical-image display section 26 and the left optical-image display section 28 are collectively simply referred to as “optical-image display sections” as well.

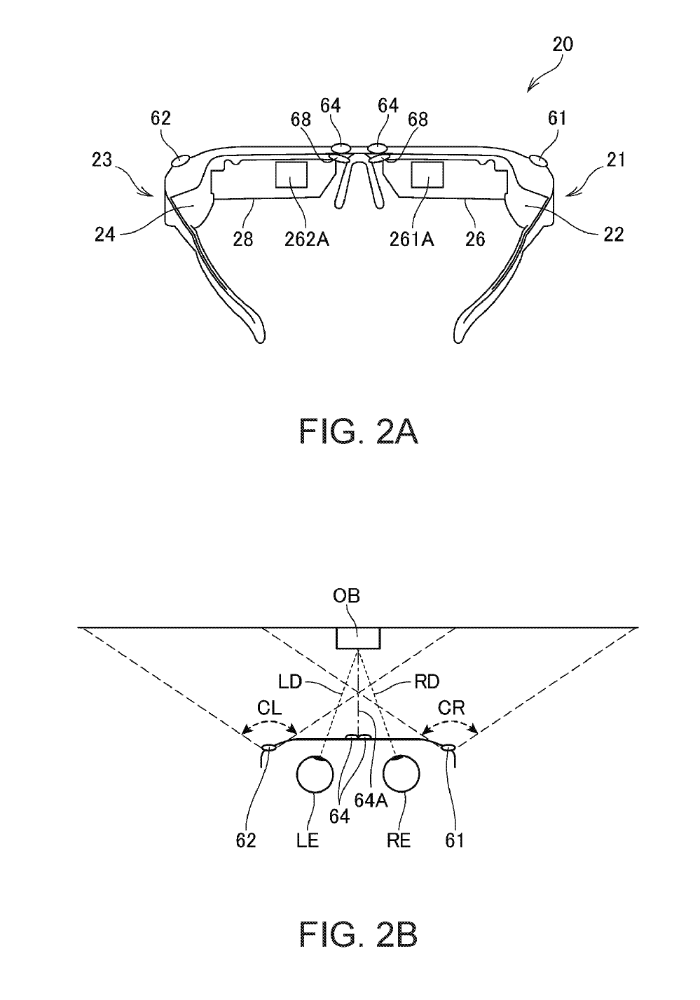

The display driving sections 22 and 24 include liquid crystal displays 241 and 242 (hereinafter referred to as “LCDs 241 and 242” as well) and projection optical systems 251 and 252 (see FIGS. 2A and 2B). Details of the configuration of the display driving sections 22 and 24 are explained below. The optical-image display sections 26 and 28 functioning as optical members include light guide plates 261 and 262 (see FIGS. 2A and 2B). The light guide plates 261 and 262 are formed of light transmissive resin or the like and guide image lights output from the display driving sections 22 and 24 to the eyes of the user. In this embodiment, explanation is made about the case in which the right optical-image display section 26 and the left optical-image display section 28 at least having light transmissivity enough for enabling the user wearing the HMD 100 to visually recognize a scene on the outside are used.

The right camera 61 and the left camera 62 explained below are disposed in the image display section 20. The right camera 61 and the left camera 62 pick up images in the front of the user according to control by the control device 10. Distance sensors 64 are provided in the image display section 20.

The image display section 20 further includes a connecting section 40 for connecting the image display section 20 to the control device 10. The connecting section 40 includes a main body cord 48 connected to the control device 10, a right cord 42, a left cord 44, and a coupling member 46. The right cord 42 and the left cord 44 are two cords branching from the main body cord 48. The right cord 42 is inserted into a housing of the right holding section 21 from a distal end portion AP in an extending direction of the right holding section 21 and connected to the right display driving section 22. Similarly, the left cord 44 is inserted into a housing of the left holding section 23 from a distal end portion AP in an extending direction of the left holding section 23 and connected to the left display driving section 24.

The coupling member 46 is provided at a branching point of the main body cord 48, the right cord 42 and the left cord 44. The coupling member 46 includes a jack for connecting an earphone plug 30. A right earphone 32 and a left earphone 34 extend from the earphone plug 30. The microphone 63 is provided in the vicinity of the earphone plug 30. Cords between the earphone plug 30 and the microphone 63 are collected as one cord. Cords branch from the microphone 63 and are respectively connected to the right earphone 32 and the left earphone 34.

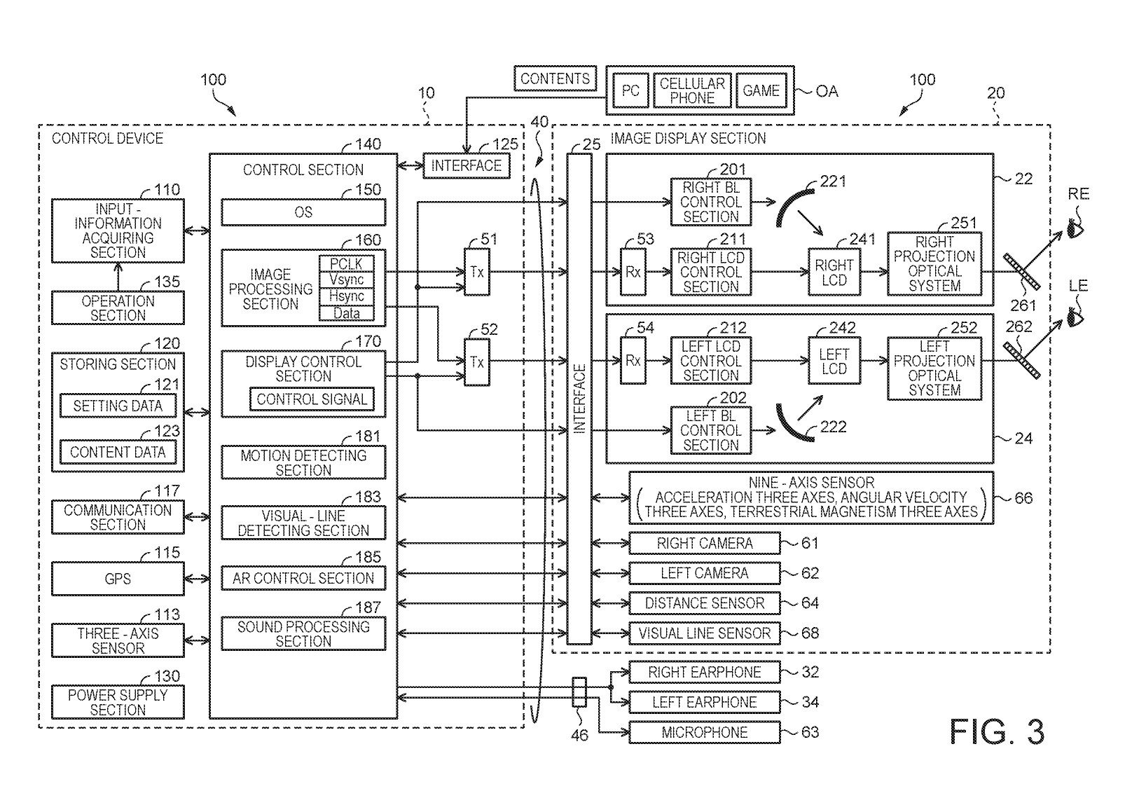

The right earphone 32 and the left earphone 34 configure a sound output section in conjunction with a voice processing section 187 (FIG. 3) explained below.

For example, as shown in FIG. 1, the microphone 63 is disposed to direct a sound collecting section of the microphone 63 to the visual line direction of the user. The microphone 63 collects sound and outputs a voice signal to a control section 140. The microphone 63 may be, for example, a monaural microphone or a stereo microphone, may be a microphone having directivity, or may be a nondirectional microphone. The microphone 63 in this embodiment is a directional microphone disposed to face the visual line direction of the user explained below with reference to FIG. 2B. Therefore, the microphone 63 most satisfactorily collects, for example, sound from substantially the front of the body and the face of the user.

Sound output by the right earphone 32 and the left earphone 34, sound collected and processed by the microphone 63, and sound processed by the voice processing section 187 are not limited to voice uttered by a human or voice similar to the voice of the human and only have to be sound such as natural sound and artificial sound. As an example, “voice” written in this embodiment includes human voice. However, this is only an example and does not limit an application range of the invention to the human voice. Frequency bands of the sound output by the right earphone 32 and the left earphone 34, the sound collected by the microphone 63, and the sound processed by the voice processing section 187 are not particularly limited either. The frequency bands of the sound output by the right earphone 32 and the left earphone 34, the sound collected by the microphone 63, and the sound processed by the voice processing section 187 may be different from one another. The right earphone 32 and the left earphone 34, the microphone 63, and the voice processing section 187 may process sound in the same frequency band. An example of the sound in the frequency band may be sound audible by the user, that is, sound in an audible frequency band of the human or may include sound having a frequency outside the audible frequency band.

The right cord 42 and the left cord 44 can be collected as one cord. Specifically, a lead wire inside the right cord 42 may be drawn into the left holding section 23 side through the inside of a main body of the image display section 20, coated with resin together with a lead wire inside the left cord 44, and collected as one cord.

The image display section 20 and the control device 10 perform transmission of various signals via the connecting section 40. Connectors (not shown in the figure), which fit with each other, are respectively provided at an end of the main body cord 48 on the opposite side of the coupling member 46 and in the control device 10. The control device 10 and the image display section 20 are connected and disconnected according to fitting and unfitting of the connector of the main body cord 48 and the connector of the control device 10. For example, a metal cable or an optical fiber can be adopted as the right cord 42, the left cord 44, and the main body cord 48.

The control device 10 controls the HMD 100. The control device 10 includes a determination key 11, a lighting section 12, a display switching key 13, a luminance switching key 15, a direction key 16, a menu key 17, and a power switch 18. The control device 10 also includes a track pad 14 operated by the user with fingers.

The determination key 11 detects pressing operation and outputs a signal for determining content of the operation in the control device 10. The lighting section 12 includes a light source such as an LED (Light Emitting Diode) and notifies, with a lighting state of the light source, an operation state of the HMD 100 (e.g., ON/OFF of a power supply). The display switching key 13 outputs, according to pressing operation, for example, a signal for instructing switching of a display mode of an image.

The track pad 14 includes an operation surface for detecting contact operation and outputs an operation signal according to operation on the operation surface. A detection type on the operation surface is not limited. An electrostatic type, a pressure detection type, an optical type, and the like can be adopted. The luminance switching key 15 outputs, according to pressing operation, a signal for instructing an increase and a decrease in the luminance of the image display section 20. The direction key 16 outputs an operation signal according to pressing operation on keys corresponding to the upward, downward, left, and right directions. The power switch 18 is a switch that switches power ON/OFF of the HMD 100.

FIGS. 2A and 2B are diagrams showing the main part configuration of the image display section 20. FIG. 2A is a main part perspective view of the image display section 20 viewed from the head side of the user. FIG. 2B is an explanatory diagram of angles of view of the right camera 61 and the left camera 62. Note that, in FIG. 2A, the right cord 42, the left cord 44, and the like connected to the image display section 20 are not shown.

FIG. 2A is a side in contact with the head of the user of the image display section 20, in other words, a side seen by a right eye RE and a left eye LE of the user. In other words, the rear sides of the right optical-image display section 26 and the left optical-image display section 28 are seen.

In an example shown in FIG. 2A, a half mirror 261A for radiating image light on the right eye RE of the user and a half mirror 262A for radiating image light on the left eye LE of the user are seen as substantially square regions. The half mirror 261A is a reflection surface included in the right light guide plate 261 that leads image light generated by the right display driving section 22 to the right eye of the user. The half mirror 262A is a reflection surface included in the left light guide plate 262 that leads image light generated by the left display driving section 24 to the left eye of the user. The image lights are made incident on the right eye and the left eye of the user by the half mirrors 261A and 262A, which are the reflection surfaces.

The entire right and left optical-image display sections 26 and 28 including the half mirrors 261A and 262A transmit external light as explained above. Therefore, the user visually recognizes an outside scene through the entire right and left optical-image display sections 26 and 28 and visually recognizes rectangular display images in the positions of the half mirrors 261A and 262A.

The right camera 61 is disposed at the end portion on the right holding section 21 side on the front surface of the HMD 100. The left camera 62 is disposed at the end portion on the left holding section 23 side on the front surface of the HMD 100. The right camera 61 and the left camera 62 are digital cameras including image pickup devices such as CCDs or CMOSs, image pickup lenses, and the like. The right camera 61 and the left camera 62 configure a stereo camera.

The right camera 61 and the left camera 62 pick up images of at least a part of an outside scene in a front side direction of the HMD 100, in other words, in a visual field direction of the user in a state in which the HMD 100 is mounted. The breadth of angles of view of the right camera 61 and the left camera 62 can be set as appropriate. In this embodiment, the angles of view of the right camera 61 and the left camera 62 are angles of view including an outside world that the user visually recognizes through the right optical-image display section 26 and the left optical-image display section 28. The right camera 61 and the left camera 62 execute image pickup according to control by the control section 140 and output picked-up image data to the control section 140.

FIG. 2B is a diagram schematically showing, in plan view, the positions of the right camera 61, the left camera 62, and the distance sensors 64 together with the right eye RE and the left eye LE of the user. An angle of view (an image pickup range) of the right camera 61 is indicated by CR. An angle of view (an image pickup range) of the left camera 62 is indicated by CL. Note that, in FIG. 2B, the angles of view CR and CL in the horizontal direction are shown. However, actual angles of view of the right camera 61 and the left camera 62 expand in the up-down direction like an angle of view of a general digital camera.

The angle of view CR and the angle of view CL are substantially symmetrical with respect to the center position of the image display section 20. Both of the angle of view CR and the angle of view CL include the right front direction in the center position of the image display section 20. Therefore, the angles of view CR and CL overlap in the front in the center position of the image display section 20.

For example, as shown in FIG. 2B, when a target object OB is present in the front direction of the image display section 20, the target object OB is included in both of the angle of view CR and the angle of view CL. Therefore, the target object OB appears in both of a picked-up image of the right camera 61 and a picked-up image of the left camera 62. When the user gazes the target object OB, the visual line of the user is directed to the target object OB as indicated by signs RD and LD in the figure. In general, a viewing angle of a human is approximately 200 degrees in the horizontal direction and approximately 125 degrees in the vertical direction. In the viewing angle, an effective field of view excellent in information acceptability is approximately 30 degrees in the horizontal direction and approximately 20 degrees in the vertical direction. Further, a stable gazing field in which a gazing point of the human is quickly and stably seen is approximately 60 to 90 degrees in the horizontal direction and approximately 45 to 70 degrees in the vertical direction.

Therefore, when the gazing point is the target object OB, the effective field of view is approximately 30 degrees in the horizontal direction and approximately 20 degrees in the vertical direction centering on the visual lines RD and LD. The stable gazing field is approximately 60 to 90 degrees in the horizontal direction and approximately 45 to 70 degrees in the vertical direction. The viewing angle is approximately 200 degrees in the horizontal direction and approximately 125 degrees in the vertical direction.

An actual visual filed visually recognized by the user wearing the HMD 100 through the right optical-image display section 26 and the left optical-image display section 28 is referred to as an actual field of view (FOV). The actual field of view is narrower than the viewing angle and the stable gazing field explained with reference to FIG. 2B but is wider than the effective field of view.

The right camera 61 and the left camera 62 are desirably capable of picking up images in a range wider than the field of view of the user. Specifically, the entire angles of view CR and CL are desirably wider than at least the effective field of view of the user. The entire angles of view CR and CL are more desirably wider than the actual field of view of the user. The entire angles of view CR and CL are still more desirably wider than the stable gazing filed of the user. The entire angles of view CR and CL are most desirably wider than the viewing angle of the user.

Therefore, in the right camera 61 and the left camera 62, the angle of view CR and the angle of view CL are arranged to overlap in the front of the image display section 20 as shown in FIG. 2B. The right camera 61 and the left camera 62 may be configured by wide-angle cameras. That is, the right camera 61 and the left camera 62 may include so-called wide-angle lenses as image pickup lenses and may be capable of picking up images in a wide angle of view. The wide-angle lens may include lenses called super-wide-angle lens and semi-wide-angle lens. The wide-angle lens may be a single focus lens or may be a zoom lens. The right camera 61 and the left camera 62 may include a lens group consisting of a plurality of lenses. The angle of view CR of the right camera 61 and the angle of view CL of the left camera 62 do not have to be the same angle. An image pickup direction of the right camera 61 and an image pickup direction of the left camera 62 do not need to be completely parallel. When a picked-up image of the right camera 61 and a picked-up image of the left camera 62 are superimposed, an image in a range wider than the field of view of the user only has to be picked up.

In FIG. 2B, a detection direction of the distance sensors 64 is indicated by sign 64A. In this embodiment, the distance sensors 64 are configured to be capable of detecting the distance from the center position of the image display section 20 to an object located in the front direction. The distance sensors 64 detect, for example, the distance to the target object OB. The user wearing the HMD 100 turns the head in a gazing direction. Therefore, it can be considered that a gazed target is present in the front of the image display section 20. Therefore, if the front of the image display section 20 is represented as the detection direction 64A, the distance sensors 64 disposed in the center of the image display section 20 can detect the distance to the target gazed by the user in the detection direction 64A.

As shown in FIG. 2A, visual line sensors 68 are disposed on the user side of the image display section 20. A pair of visual line sensors 68 is provided in the center position between the right optical-image display section 26 and the left optical-image display section 28 to respectively correspond to the right eye RE and the left eye LE of the user.

The visual line sensors 68 are configured by, for example, a pair of cameras that respectively picks up images of the right eye RE and the left eye LE of the user. The visual line sensors 68 perform image pickup according to control by the control section 140 (FIG. 3). The control section 140 detects images of reflected lights and the pupils on the eyeball surfaces of the right eye RE and the left eye LE from picked-up image data and specifies a visual line direction.

Note that a configuration for detecting the visual line direction is not limited to the visual line sensors 68. For example, a visual line may be estimated by, for example, measuring eye potential of the eyes or muscle potential of the ocular muscles of the user and detecting an eyeball motion. The visual line direction may be specified by calculating a direction of the HMD 100 from picked-up images of the right camera 61 and the left camera 62.

FIG. 3 is a functional block diagram of the sections configuring the HMD 100.

As shown in FIG. 3, the HMD 100 is connected to an external apparatus OA via an interface 125. The interface 125 is an interface for connecting various external apparatuses OA, which are supply sources of contents, to the control device 10. As the interface 125, interfaces adapted to wired connection such as a USB interface, a micro USB interface, or an interface for a memory card can be used.

The external apparatus OA is used as an image supply apparatus that supplies an image to the HMD 100. For example, a personal computer (PC), a cellular phone terminal, or a game terminal is used.

The control device 10 of the HMD 100 includes a control section 140, an operation section 111, an input-information acquiring section 110, a storing section 120, and a transmitting section (Tx) 51 and a transmitting section (Tx) 52.

The input-information acquiring section 110 is connected to the operation section 111. The operation section 111 detects operation by the user. The operation section 111 includes operators for the determination key 11, the display switching key 13, the track pad 14, the luminance switching key 15, the direction key 16, the menu key 17, and the power switch 18 shown in FIG. 1. The input-information acquiring section 110 acquires input content on the basis of a signal input from the operation section 111. The control device 10 further includes a power supply section 130 that supplies electric power to the sections of the control device 10 and the image display section 20.

The storing section 120 is a nonvolatile storage device and has stored therein various computer programs. In the storing section 120, image data to be displayed on the image display section 20 of the HMD 100 may be stored. For example, the storing section 120 stores setting data 121 including setting values and the like related to the operation of the HMD 100 and content data 123 including data of characters and images that the control section 140 causes the image display section 20 to display.

A three-axis sensor 113, a GPS 115, and a communication section 117 are connected to the control section 140. The three-axis sensor 113 is a three-axis acceleration sensor. The control section 140 is capable of acquiring a detection value of the three-axis sensor 113. The GPS 115 includes an antenna (not shown in the figure), receives a GPS (Global Positioning System) signal, and calculates the present position of the control device 10. The GPS 115 outputs the present position and the present time calculated on the basis of the GPS signal to the control section 140. The GPS 115 may include a function of acquiring the present time on the basis of information included in the GPS signal and correcting time clocked by the control section 140 of the control device 10.

The communication section 117 executes wireless data communication conforming to a standard of wireless communication such as a wireless LAN (WiFi (registered trademark)) or a Miracast (registered trademark). The communication section 117 is also capable of executing wireless data communication conforming to a standard of short-range wireless communication such as Bluetooth (registered trademark), Bluetooth Low Energy, RFID, or Felica (registered trademark).

When the external apparatus OA is connected to the communication section 117 by radio, the control section 140 acquires content data from the communication section 117 and performs control for displaying an image on the image display section 20. On the other hand, when the external apparatus OA is connected to the interface 125 by wire, the control section 140 acquires content data from the interface 125 and performs control for displaying an image on the image display section 20. Therefore, the communication section 117 and the interface 125 are hereinafter collectively referred to as data acquiring section DA.

The data acquiring section DA acquires content data from the external apparatus OA. The data acquiring section DA acquires data of an image displayed by the HMD 100 from the external apparatus OA.

On the other hand, the image display section 20 includes an interface 25, the right display driving section 22, the left display driving section 24, the right light guide plate 261 functioning as the right optical-image display section 26, the left light guide plate 262 functioning as the left optical-image display section 28, the right camera 61, the left camera 62, a vibration sensor 65, and a nine-axis sensor 66 (a movement sensor).

The vibration sensor 65 is configured using an acceleration sensor and disposed on the inside of the image display section 20. The vibration sensor 65 is incorporated, for example, in the vicinity of the end portion ER of the right optical-image display section 26 in the right holding section 21. When the user performs operation of knocking the end portion ER (knock operation), the vibration sensor 65 detects vibration due to the operation and outputs a result of the detection to the control section 140. The control section 140 detects the knock operation by the user according to the detection result of the vibration sensor 65.

The nine-axis sensor 66 is a motion sensor that detects acceleration (three axes), angular velocity (three axes), and terrestrial magnetism (three axes). The nine-axis sensor 66 executes detection according to control by the control section 140 and outputs detection values to the control section 140.

The interface 25 includes a connector to which the right cord 42 and the left cord 44 are connected. The interface 25 outputs a clock signal PCLK, a vertical synchronization signal VSync, a horizontal synchronization signal HSync, and image data Data transmitted from the transmitting section 51 to a receiving section (Rx) 53 or 54 corresponding to the transmitting section 51. The interface 25 outputs a control signal transmitted from a display control section 170 to the receiving section 53 or 54 and a right backlight control section 201 or a left backlight control section 202 corresponding to the display control section 170.

The interface 25 is an interface that connects the right camera 61, the left camera 62, the distance sensors 64, the nine-axis sensor 66, and the visual line sensors 68. Picked-up image data of the right camera 61 and the left camera 62, a detection result of the distance sensors 64, detection results of acceleration (three axes), angular velocity (three axes), and terrestrial magnetism (three axes) by the nine-axis sensor 66, and a detection result of the visual line sensors 68 are sent to the control section 140 via the interface 25.

The right display driving section 22 includes the receiving section 53, the right backlight (BL) control section 201 and a right backlight (BL) 221 functioning as a light source, a right LCD control section 211 and the right LCD 241 functioning as a display element, and the right projection optical system 251. The right backlight control section 201 and the right backlight 221 functions as the light source. The right LCD control section 211 and the right LCD 241 function as the display element. Note that the right backlight control section 201, the right LCD control section 211, the right backlight 221, and the right LCD 241 are collectively referred to as “image-light generating section” as well.

The receiving section 53 functions as a receiver for serial transmission between the control device 10 and the image display section 20. The right backlight control section 201 drives the right backlight 221 on the basis of an input control signal. The right backlight 221 is, for example, a light emitting body such as an LED or an electroluminescence (EL) element. The right LCD control section 211 drives the right LCD 241 on the basis of the clock signal PCLK, the vertical synchronization signal VSync, the horizontal synchronization signal HSync, and the image data for right eye Data input via the receiving section 53. The right LCD 241 is a transmissive liquid crystal panel on which a plurality of pixels are arranged in a matrix shape.

The right projection optical system 251 is configured by a collimate lens that changes image light emitted from the right LCD 241 to light beams in a parallel state. The right light guide plate 261 functioning as the right optical-image display section 26 guides, along a predetermined optical path, the image light output from the right projection optical system 251, reflects the image light on the half mirror 261A, and guides the image light to the right eye RE of the user.

The left display driving section 24 includes a configuration same as the configuration of the right display driving section 22. The left display driving section 24 includes the receiving section 54, the left backlight (BL) control section 202 and a left backlight (BL) 222 functioning as a light source, a left LCD control section 212 and the left LCD 242 functioning as a display element, and the left projection optical system 252. The left backlight control section 202 and the left backlight 222 function as the light source. The left LCD control section 212 and the left LCD 242 functions as the display element. The left projection optical system 252 is configured by a collimate lens that changes image light emitted from the left LCD 242 to light beams in a parallel state. The left light guide plate 262 functioning as the left optical-image display section 28 guides, along a predetermined optical path, the image light output from the left projection optical system 252, reflects the image light on the half mirror 262A, and guides the image light to the left eye LE of the user.

The control section 140 includes a CPU, a ROM, and a RAM (all of which are not shown in the figure) as hardware. The control section 140 reads out and executes a computer program stored in the storing section 120 to thereby function as an operating system (OS) 150, an image processing section 160, a display control section 170, a motion detecting section 181, a visual-line detecting section 183, an AR control section 185 (a processing section), and the voice processing section 187.

The image processing section 160 outputs the vertical synchronization signal VSync, the horizontal synchronization signal HSync, the clock signal PCLK, and the like for displaying contents and image data (in the figure, Data) of an image to be displayed.

The image data of the contents displayed by the processing of the image processing section 160 is received via the interface 125 and the communication section 117. Besides, the image data may be image data generated by processing of the control section 140. For example, during execution of an application program of a game, image data can be generated and displayed according to operation of the operation section 111.

Note that the image processing section 160 may execute, according to necessity, image processing such as resolution conversion processing, various kinds of color tone correction processing such as adjustment of luminance and chroma, and keystone correction processing on the image data.

The image processing section 160 transmits the clock signal PCLK, the vertical synchronization signal VSync, and the horizontal synchronization signal HSync generated by the image processing section 160 and the image data Data stored in a DRAM in the storing section 120 respectively via the transmitting sections 51 and 52. Note that the image data Data transmitted via the transmitting section 51 is referred to as “image data for right eye” as well and the image data Data transmitted via the transmitting section 52 is referred to as “image data for left eye” as well. The transmitting sections 51 and 52 function as a transceiver for serial transmission between the control device 10 and the image display section 20.

The display control section 170 generates a control signal for controlling the right display driving section 22 and the left display driving section 24. Specifically, the display control section 170 individually controls, according to the control signal, driving ON/OFF of the right LCD 241 by the right LCD control section 211 and driving ON/OFF of the right backlight 221 by the right backlight control section 201. The display control section 170 individually controls driving ON/OFF of the left LCD 242 by the left LCD control section 212 and driving ON/OFF of the left backlight 222 by the left backlight control section 202.

Consequently, the display control section 170 controls generation and emission of image lights respectively by the right display driving section 22 and the left display driving section 24. For example, the display control section 170 causes both of the right display driving section 22 and the left display driving section 24 to generate image lights or causes only one of the right display driving section 22 and the left display driving section 24 to generate image light. The display control section 170 can also prevent both of the right display driving section 22 and the left display driving section 24 from generating image light.

The display control section 170 transmits a control signal for the right LCD control section 211 and a control signal for the left LCD control section 212 respectively via the transmitting section 51 and the transmitting section 52. The display control section 170 transmits a control signal for the right backlight control section 201 to the right backlight control section 201 and transmits a control signal for the left backlight control section 202 to the left backlight control section 202.

The motion detecting section 181 acquires a detection value of the nine-axis sensor 66 and detects a movement of the head of the user wearing the image display section 20. The motion detecting section 181 acquires a detection value of the nine-axis sensor 66 at a cycle set in advance and detects acceleration and angular velocity concerning a movement of the image display section 20. The motion detecting section 181 can detect the direction of the image display section 20 on the basis of a detection value of terrestrial magnetism of the nine-axis sensor 66. The motion detecting section 181 can calculate the position and the direction of the image display section 20 by integrating detection values of the acceleration and the angular velocity of the nine-axis sensor 66. In this case, the motion detecting section 181 sets, as reference positions, the position and the direction of the image display section 20 at a detection start time or a designated reference time, and calculates amounts of changes of the position and the direction from the reference positions.

The motion detecting section 181 causes the right camera 61 and the left camera 62 to execute image pickup and acquires picked-up image data. The motion detecting section 181 may detect changes in the position and the direction of the image display section 20 from the picked-up image data of the right camera 61 and the left camera 62. The motion detecting section 181 can calculate the position and the direction of the image display section 20 by detecting amounts of changes of the position and the direction of the image display section 20 at a cycle set in advance. In this case, as explained above, the method of integrating amounts of changes in the position and the direction from the reference positions can be used.

The visual-line detecting section 183 specifies a visual line direction of the user using the visual line sensors 68 disposed in the image display section 20 as shown in FIG. 2A. The visual-line detecting section 183 calculates visual lines of the right eye RE and the left eye LE of the user on the basis of picked-up images of the left and right pair of visual line sensors 68 and specifies a gazing direction of the user. The gazing direction of the user can be calculated as the center between a visual line direction RD of the right eye RE and a visual line direction LD of the left eye LE, for example, as shown in FIG. 2B. When data for setting a dominant eye of the user is included in the setting data 121, the visual-line detecting section 183 can set, on the basis of the data, a position close to the dominant eye side as the gazing direction of the user.

The AR control section 185 causes the image display section 20 to display AR contents. The AR contents include, in a state in which the user is viewing a target object in an outside scene, that is, a real space (e.g., the target object OB shown in FIG. 2B) through the image display section 20, characters and images displayed to correspond to a position where the target object is visually recognized. The target object only has to be an object and may be an immovable object such as a wall surface of a building or may be a natural object. The AR control section 185 displays the AR contents to be seen by the user, for example, over the target object OB or seen in a position avoiding the target object OB. A display method of this type is referred to as AR display. The AR control section 185 can provide information concerning the target object or change the appearance of a figure of the target object seen through the image display section 20 by performing the AR display of characters and images.

The AR contents are displayed on the basis of the content data 123 stored in the storing section 120 or data generated by processing of the control section 140. These data can be included in image data and text data.

The AR control section 185 detects a position where the user visually recognizes the target object and determines a display position of the AR contents to correspond to the detected position. A method of detecting the position where the user visually recognizes the target object is optional.

The AR control section 185 in this embodiment detects the target object located in the visual field of the user from the picked-up image data of the right camera 61 and the left camera 62. The AR control section 185 analyzes the picked-up image data and extracts or detects an image of the target object using data of feature values concerning the shape, the color, the size, and the like of the image of the target object. The feature values and the other data used in this processing can be included in the content data 123.

After detecting the image of the target object from the picked-up image data, the AR control section 185 calculates the distance to the target object. For example, the AR control section 185 calculates a parallax from a difference between the picked-up image data of the right camera 61 and the picked-up image data of the left camera 62 and calculates the distance from the image display section 20 to the target object on the basis of the calculated parallax. For example, the AR control section 185 calculates the distance to the target object on the basis of a detection value of the distance sensors 64. The AR control section 185 may calculate the distance to the target object using both of the processing for calculating the distance using the picked-up image data of the right camera 61 and the left camera 62 and the processing for calculating the distance using the detection values of the distance sensors 64. For example, the AR control section 185 may detect, with the distance sensors 64, the distance to the target object located in the front or in the vicinity of the front of the distance sensors 64 and calculate the distance to the target object present in a position apart from the front of the distance sensors 64 by analyzing the picked-up image data.

The AR control section 185 calculates a relative positional relation (the distance, the direction, etc.) between the image display section 20 and the target object and determines, on the basis of the calculated positional relation, a display position of the AR contents corresponding to the position of the target object.

The AR control section 185 executes processing concerning sound. Specifically, the AR control section 185 causes, through processing of the voice processing section 187, the right earphone 32 and the left earphone 34 to output voice based on voice data included in the content data 123 or voice data generated by control by the control section 140. The AR control section 185 acquires voice data of voice collected by the microphone 63, execute predetermined processing on the acquired voice data, and generates output voice data. The AR control section 185 causes, through the processing of the voice processing section 187, the right earphone 32 and the left earphone 34 to output voice based on the output voice data. Sound processed by the AR control section 185 and the voice processing section 187 is not limited to voice uttered by a human or voice similar to the voice of the human and only has to be sound such as natural sound or artificial sound. In this embodiment, the sound is written as “voice” and processing of human voice is also explained. However, this does not mean that the “voice” is limited to the human voice. The “voice” may include natural sound and artificial sound. An application range of the invention is not limited to the human voice. A frequency band of the sound and voice processed by the AR control section 185 is not limited. For example, the “voice” can be sound audible by the user and can be sound in an audible frequency band of the human.

When a voice signal of collected voice is input from the microphone 63 to the control section 140, the AR control section 185 generates digital voice data based on the voice signal. Note that an A/D converter (not shown in the figure) may be provided between the microphone 63 and the control section 140 to convert an analog voice signal into digital voice data and input the digital voice data to the control section 140. When the voice collected by the microphone 63 includes voices (sounds) from a plurality of sound sources, the AR control section 185 can identify and extract voice for each of the sound sources. For example, the AR control section 185 can extract, from the voice collected by the microphone 63, background sound, sound emitted by a sound source located in a gazing direction of the user, and sound other than the background sound and the sound emitted by the sound source.

The AR control section 185 may execute voice recognition processing on the voice collected by the microphone 63 or voice extracted from the voice. This processing is effective, for example, when the voice collected by the microphone 63 is human voice. In this case, the AR control section 185 extracts characteristics from digital voice data of the voice collected by the microphone 63, models the characteristics, and performs text conversion for converting the voice into a text. The AR control section 185 may store the text after the conversion as text data, may display the text after the conversion on the image display section 20 as a text, or may convert the text into voice and output the voice from the right earphone 32 and the left earphone 34.

After converting the voice collected by the microphone 63 into the text, the AR control section 185 may execute translation into a text of a different language and output voice based on the text after the translation.

The voice processing section 187 generates an analog voice signal on the basis of output voice data processed by the AR control section 185, amplifies the analog voice signal, and outputs the analog voice signal to a speaker (not shown in the figure) in the right earphone 32 and a speaker (not shown in the figure) in the left earphone 34. Note that, for example, when a Dolby (registered trademark) system is adopted, processing for a voice signal is performed. Different kinds of sound with, for example, varied frequencies are respectively output from the right earphone 32 and the left earphone 34.

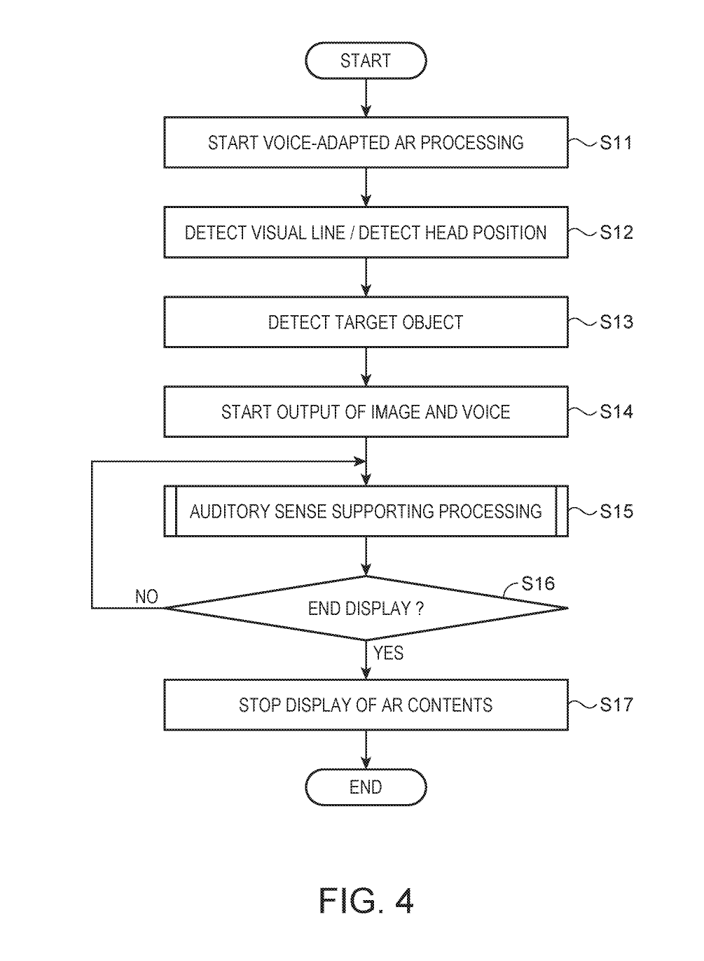

FIG. 4 is a flowchart for explaining the operation of the HMD 100. In particular, the AR display and an operation for outputting voice corresponding to the AR display is shown in the figure.

The control section 140 starts voice-adapted AR processing while being triggered by operation of the user on the control device 10 or a function of an application program executed by the control section 140 (step S11). The voice-adapted AR processing is processing for executing the AR display and an input or an output of voice in association with each other.

The control section 140 detects, with the function of the visual-line detecting section 183, a visual line direction of the user wearing the image display section 20 and detects, with the function of the motion detecting section 181, the position and the direction of the head of the user (step S12). Subsequently, the control section 140 detects target objects present in a real space in an image pickup range of the right camera 61 and the left camera 62 (step S13).

In step S13, the control section 140 detects one target object located in the visual line direction of the user and sets the target object as a target of the AR display. The control section 140 may detect a plurality of target objects appearing in picked-up images of the right camera 61 and the left camera 62. In this case, the control section 140 selects the target of the AR display from the plurality of target objects.

The control section 140 starts, according to a position where the user views the target object of the AR display through the image display section 20, processing for displaying an image of AR contents and processing for outputting voice related to the AR contents (step S14). The processing for outputting the voice in step S14 is equivalent to the sound output processing.

The control section 140 executes auditory sense supporting processing (step S15). The auditory sense supporting processing is processing for allowing the user to easily hear voice output by the HMD 100 according to the AR display or voice related to the target object of the AR display. In the auditory sense supporting processing, control of the output of the voice and control of display affecting an audio effect are performed.

The control section 140 determines whether to end the AR display (step S16). If determining not to end the AR display (No in step S16), the control section 140 continues the auditory sense supporting processing in step S15. If determining to end the AR display (Yes in step S16), the control section 140 stops the display and the voice output started in step S14 (step S17) and ends the processing.

In the auditory sense supporting processing, the control section 140 operates to improve the audibility of the sound related to the target object and allow the user to easily hear the voice. Therefore, the control section 140 performs processing that makes use of a cocktail party effect, a Doppler effect, a McGurk effect, a Haas effect known concerning a visual sense and/or an auditory sense.

Explanation of First Processing (Acoustic Processing that Makes Use of the Cocktail Party Effect)

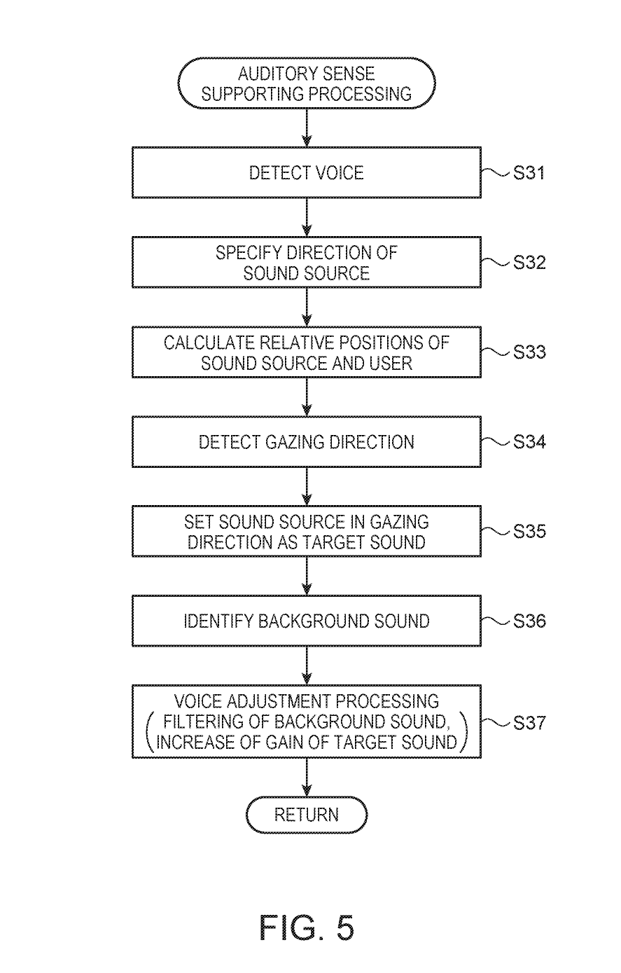

FIG. 5 is a flowchart for explaining the operation of the HMD 100. An operation example is shown in which the control section 140 performs, as the auditory sense supporting processing, first processing that makes use of the cocktail party effect.

The cocktail party effect refers to a human ability for selectively catch sound in a situation in which a large number of sounds are heard. For example, voice uttered by a specific person can be caught in a situation in which voices uttered by a plurality of humans can be simultaneously heard. This is known as an ability concerning an audio scene analysis in a sensory system of a human. The cocktail party effect is conspicuous when voice is heard by both the ears. Therefore, it is conceivable that an ability for sensing the direction of a sound source relates to the cocktail party effect.

The first processing shown in FIG. 5 is executed when the control section 140 acquires voice collected by the microphone 63 and outputs, from the right earphone 32 and the left earphone 34, the collected voice or voice generated by applying processing to the collected voice. Therefore, the first processing is applied when the control section 140 outputs, as the voice related to the AR display, the voice collected by the microphone 63 or the voice based on the collected voice in step S14 in FIG. 4.

In the first processing, the control section 140 performs processing for supporting the ability for selectively hearing sound in a situation in which sounds from a plurality of sound sources are heard in a mixed state like the cocktail party effect.

The control section 140 acquires voice data of the voice collected by the microphone 63 and detects the voice (step S31).

For example, in step S31, the control section 140 executes arithmetic processing including Fourier transform on the voice data collected by the microphone 63, converts the collected voice into a frequency region, and extracts an audible frequency component of a human. The control section 140 extracts a component of a frequency band of voice uttered by the human to thereby separate the voice into human voice and environmental sound other than the human voice. When the voice collected by the microphone 63 includes voices of a plurality of humans, the control section 140 separates and detects voice of each of talkers.

Concerning the voice detected in step S31, the control section 140 performs processing for specifying the direction of a sound source (step S32). When a plurality of voices (e.g., a plurality of human voices) are detected in step S31, the control section 140 specifies the directions of sound sources of the respective voices.

The control section 140 calculates a relative positional relation between the respective sound sources specified in step S32 and the image display section 20 (step S33).

For example, in steps S32 and S33, when specifying the target object on the basis of the picked-up image in step S13, the control section 140 may estimate a position relative to the target object. The control section 140 may compare, for example, volume of the sound source detected in step S31 with the direction of the HMD 100 and estimate the direction of the sound source. The control section 140 may associate the position of the target object calculated by the method explained above and the direction of the sound source calculated by the method explained above and specify a relative positional relation of the image display section 20 to the sound source.

The control section 140 detects a gazing direction of the user wearing the image display section 20 (step S34). The gazing direction of the user can be rephrased as a visual line direction of the user. In step S34, the control section 140 may perform processing for specifying a visual line direction with the visual-line detecting section 183. In step S34, the control section 140 detects a movement of the image display section 20 with the motion detecting section 181 to thereby detect the direction of the image display section 20, combines a result of the detection with a result of the processing of the visual-line detecting section 183, and detects a gazing direction of the user. Note that, in step S34, the control section 140 may use the processing results in steps S12 to S13 (FIG. 4).

The control section 140 specifies, on the basis of the direction of the sound source specified in step S32 and the gazing direction detected in step S34, a sound source located in the gazing direction of the user and sets the sound source as a sound source of processing target sound (step S35). Consequently, it is possible to distinguish and process voice from the sound source located in the gazing direction of the user and voice reaching the image display section 20 from a sound source located in a direction other than the gazing direction. In step S35, the control section 140 may set a plurality of sound sources as a sound source of the target sound. The control section 140 indentifies, as background sound, sound that is not human voice among sounds from sound sources different from the sound source set in step S35 (step S36). The background sound is, for example, the sound detected in step S31 as the environmental sound that is not human voice.

The control section 140 executes, on the voice collected by the microphone 63, voice adjustment processing for improving the audibility of the target sound set in step S35 (step S37). In the voice adjustment processing, the control section 140 filters the background sound identified in step S36, reduces the volume of the background sound, and increases the volume of the target sound set in step S35.

According to the processing shown in FIG. 5, in a situation in which the voices emitted by the plurality of sound sources are audible in a mixed state, the control section 140 can increase the volume of the voice reaching the image display section 20 from the sound source in the visual line direction of the user to make it easier to hear the voice than the other voices.

Note that, in the processing shown in FIG. 5, an example is explained in which the control section 140 separates the voice into the human voice and the environmental sound other than the human voice in step S31 and sets the sound source located in the gazing direction of the user in the human voice as a sound source of the target sound in step S35. The invention is not limited to this. Sound that is not human voice can be set as the target sound. In this case, in step S31, processing is performed not to change sound that is likely to be the target sound to the environmental sound.

The first processing shown in FIG. 5 corresponds to the output control processing including the sound processing according to the invention when the first processing does not include processing for the image displayed on the image display section 20. The processing shown in FIG. 5 can also be executed together with processing for changing an image displayed on the image display section 20. For example, a text, an image, and the like may be displayed by the image display section 20 to improve the visibility of the sound source set in step S35. When the voice adjustment processing is performed in step S37, a text, an image, and the like concerning content of the voice adjustment processing may be displayed.

Explanation of Second Processing (Processing that Makes Use of the Cocktail Party Effect)

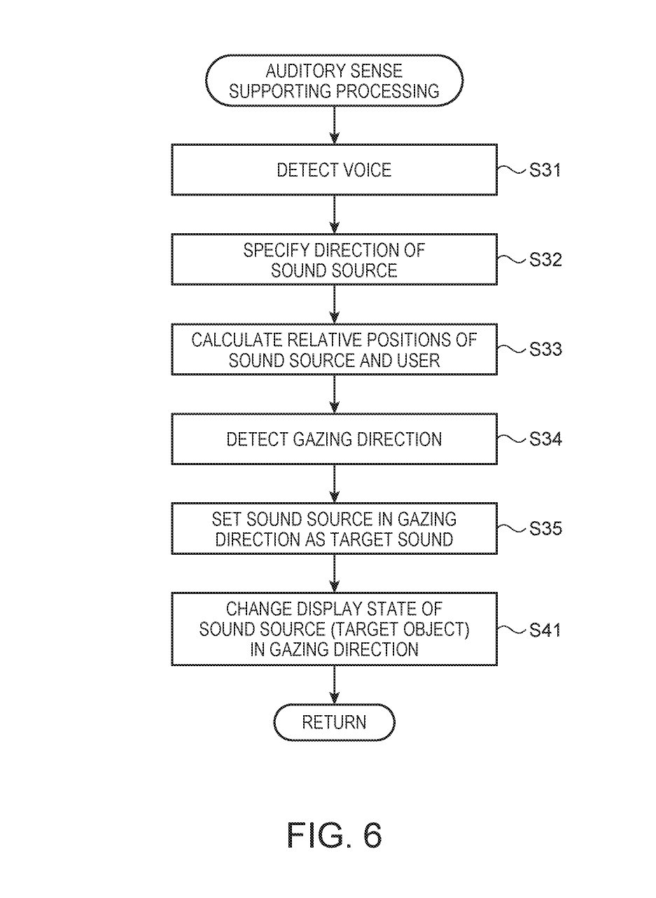

FIG. 6 is a flowchart for explaining the operation of the HMD 100. An operation example is shown in which the control section 140 performs, as the auditory sense supporting processing, second processing that makes use of the cocktail party effect.

The second processing shown in FIG. 6 is executed when the control section 140 does not output both of voice collected by the microphone 63 and voice generated by applying processing to the collected voice from the right earphone 32 and the left earphone 34. Therefore, the second processing shown in FIG. 6 is applied when voice related to the AR display is not output in step S14 in FIG. 4 and the user directly hears sound in a real space with both the ears.

In the second processing, in a situation in which sounds from a plurality of sound sources are heard in a mixed state like the cocktail party effect, the control section 140 controls display by the image display section 20 in order to support the ability for selectively hearing sound.

Steps S31 to S35 in FIG. 6 are processing same as the processing explained with reference to FIG. 5. Therefore, the same step numbers are attached to the steps and explanation of the steps is omitted.

In step S35, the control section 140 specifies a sound source located in the gazing direction of the user and sets the sound source as a sound source of processing target sound (step S35). Thereafter, the control section 140 selects, among the target objects detected in step S13 (FIG. 4), a target object located in a direction same as the direction of the sound source set in step S35 and causes the image display section 20 to display an AR image for improving the visibility of the target object (step S41).

Specifically, the control section 140 selects, among the target objects detected in step S13 (FIG. 4), a target object located in a direction same as the direction of the sound source set in step S35 and sets the target object as a target object of the auditory sense supporting processing. The control section 140 causes the image display section 20 to display an image and a text to highlight the set target object. For example, the control section 140 arranges characters or an image for highlighting the target object and displays the characters or the image as an AR image in a position overlapping the set target object or around the set target object. For example, the control section 140 acquires an image of the set target object from picked-up images of the right camera 61 and the left camera 62, enlarges the acquired image, and displays the image in a position where the image is seen over the target object in the real space.

As a method of improving the visibility of the target object, besides the AR display of the characters or the image for highlighting the target object, it is possible to adopt a method of displaying an image or the like for reducing the visibility of an object or a space other than the target object. For example, an image for reducing visibility such as an image having high luminance, a geometrical pattern, or a single-color painted-out image only has to be displayed to overlap the object or the space other than the target object. The image for reducing visibility may be realized by providing an electronic shutter or the like different from the right light guide plate 261 and the left light guide plate 262 in the image display section 20.

Consequently, the user is more strongly aware of and gazes the target object (the sound source) located in the gazing direction. Therefore, it possible to expect that the cocktail party effect becomes more conspicuous. As a result, the user can clearly catch voice heard from the gazing direction of the user. It is possible to improve the audibility of sound intentionally selected by the user.

The second processing shown in FIG. 6 includes processing for an image displayed by the image display section 20 and is equivalent to the output control processing according to the invention. The second processing may be performed in parallel to processing for outputting voice (sound) from the right earphone 32 and the left earphone 34. For example, the second processing may be performed together with processing for outputting voice from the right earphone 32 and the left earphone 34 based on voice data stored by the HMD 100 in advance or voice data input from the external apparatus OA. Alternatively, the second processing may be performed together with processing for processing voice collected by the microphone 63 in the voice processing section 187 and outputting the voice from the right earphone 32 and the left earphone 34. The first processing shown in FIG. 5 and the second processing shown in FIG. 6 may be executed in combination.

### Explanation of Third Processing (Processing Corresponding to the Doppler Effect)

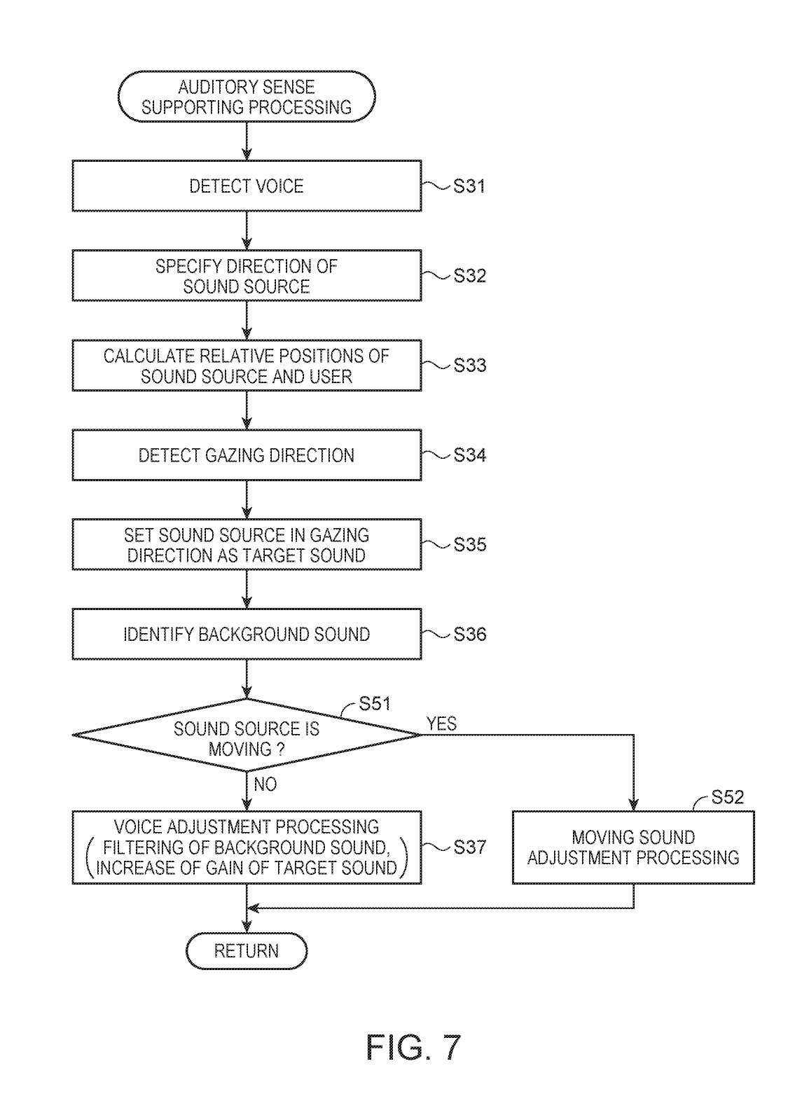

FIG. 7 is a flowchart for explaining the operation of the HMD 100. An operation example is shown in which the control section 140 performs, as the auditory sense supporting processing, third processing corresponding to the Doppler effect.

The Doppler effect concerning voice refers to a phenomenon in which the tone of sound is sensed differently when a sound source moves relatively to an observer (a user) (while relative positions of the user and the sound source change). For example, sound emitted by the sound source is heard as high sound while the sound source moves close to the user. The sound emitted by the sound source is heard as low sound while the sound source moves away from the user. In the third processing, when a sound source in the gazing direction of the user is moving, the control section 140 executes acoustic processing to reduce a change in a frequency (a change in the tone of sound sensed by the user) due to the Doppler effect and improves the audibility of the sound from the sound source.

The third processing shown in FIG. 7 is executed when the control section 140 acquires voice collected by the microphone 63 and outputs the collected voice or voice generated by applying processing to the collected voice from the right earphone 32 and the left earphone 34. Therefore, the third processing is applied when the voice collected by the microphone 63 or the voice based on the collected voice is output as voice related to the AR display.

Steps S31 to S37 in FIG. 7 are processing same as the processing explained with reference to FIG. 5. Therefore, the same step numbers are attached to the steps and explanation of the steps is omitted.

The control section 140 determines whether the sound source set as the sound source of the processing target sound in step S35 is moving (step S51). For example, the control section 140 can monitor the distance to the processing target sound source using the detection result of the distance sensors and determine whether the sound source is moving. Alternatively, the control section 140 can detect an image of the target sound source from the picked-up image data of the right camera 61 and the left camera 62 and determine on the basis of presence or absence of a change in the size of the detected image whether the sound source is moving.

When determining that the sound source is not moving (No in step S51), the control section 140 shifts to step S37. When determining that the sound source is moving (Yes in step S51), the control section 140 executes moving sound adjustment processing for adjusting sound of the moving sound source (step S52). In the moving sound adjustment processing, the control section 140 calculates moving speed of the moving sound source and corrects, on the basis of the moving speed of the sound source, the frequency of sound emitted by the sound source. The moving speed of the sound source is relative speed to the image display section 20 and is, in particular, a speed component in a direction in which the sound source moves close to or away from the user or the HMD 100. That is, the control section 140 calculates speed in the direction in which the sound source moves close to or away from the user rather than the moving speed itself of the sound source. Further, the control section 140 calculates, on the basis of the speed of the sound source and whether the sound source is moving close to or away from the user, a correction parameter for correcting the sound emitted by the sound source. The correction parameter is an amount of change for changing the frequency (the number of vibrations) of the sound and is equivalent to the “auditory sense information” according to the invention. The control section 140 extracts the sound emitted by the moving sound in the sound collected by the microphone 63, performs conversion processing for correcting the frequency (the number of vibrations) of the extracted sound and converting the extracted sound into sound having a different frequency (number of vibrations), and outputs the sound after the conversion.

Consequently, the user can hear, in a state without fluctuation in a frequency due to the Doppler effect or a state in which the fluctuation is suppressed, the voice emitted by the target object (the sound source) located in the gazing direction. Therefore, the user can hear the voice emitted by the sound source as sound having a more natural tone. It is possible to expect improvement of audibility.

The third processing shown in FIG. 7 corresponds to the output control processing including the sound processing according to the invention. The processing shown in FIG. 7 does not include the processing for the image displayed by the image display section 20. However, the processing can also be executed together with processing for changing the image displayed by the image display section 20. For example, a text, an image, or the like may be displayed by the image display section 20 to improve the visibility of the sound source set in step S35. When the voice adjustment processing is performed in step S37, a text, an image, or the like concerning content of the voice adjustment processing may be displayed.

### Explanation of Fourth Processing (Processing Corresponding to the McGurk Effect)

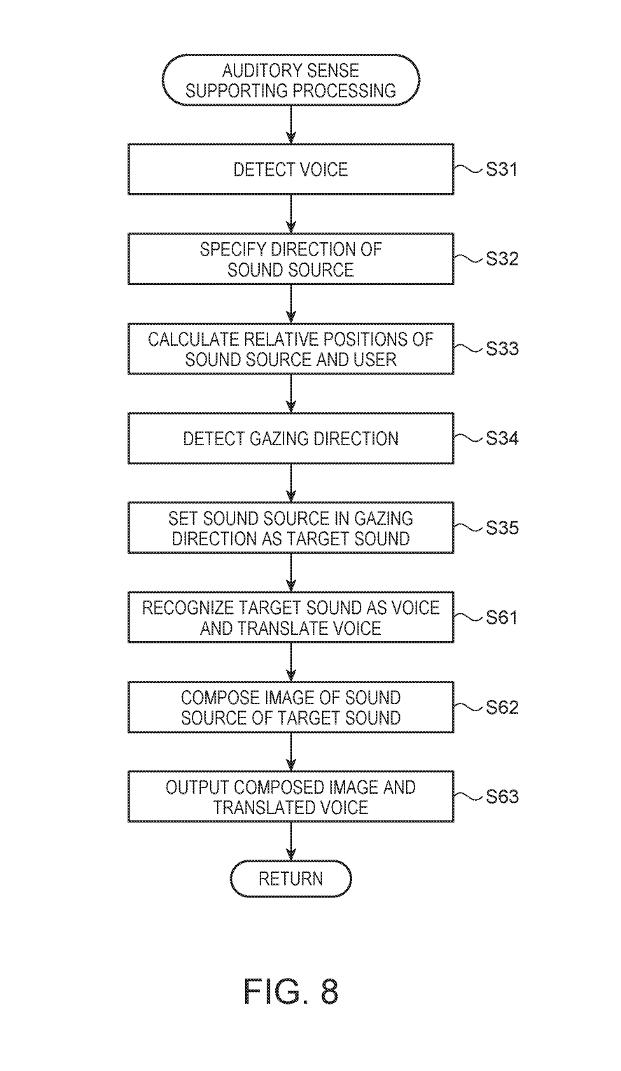

FIG. 8 is a flowchart for explaining the operation of the HMD 100. An operation example is shown in which the control section 140 performs fourth processing corresponding to the McGurk effect as the auditory sense supporting processing.

The McGurk effect is an effect concerning hearing of voice uttered by a human. The McGurk effect refers to a phenomenon in which, when vocal sound identified by the auditory sense and vocal sound identified by the visual sense are different, vocal sound different from both the vocal sounds is sensed. In a well-known example, when a test subject hears voice “ba” with the auditory sense and visually recognizes a video of the mouth of a human uttering “ga”, vocal sound sensed by the test subject is “da” obtained by uniting or mixing “ba” and “ga”.

As explained above, the control section 140 is capable of converting the voice collected by the microphone 63 into a text and further performing the translation. In this case, the control section 140 performs reading processing of the text after the translation is performed and outputs the voice after the translation from the right earphone 32 and the left earphone 34. When the translation processing and the translated voice output processing are executed, the user recognizes, with the visual sense, the face of a person uttering voice before translation in the real space and recognizes the voice after the translation with the auditory sense. Therefore, it is likely that the user less easily senses the voice after the translation because of the McGurk effect.

When the translation processing and the translated voice output processing are executed, the fourth processing shown in FIG. 8 is executed in order to control the display of the image displayed by the image display section 20 and improve the audibility of the voice after the translation.

Steps S31 to S35 in FIG. 8 are processing same as the processing explained with reference to FIG. 5. Therefore, the same step numbers are attached to the steps and explanation of the steps is omitted.

The control section 140 performs text conversion on sound from the sound source set as the sound source of the processing target sound in step S35 and translates the text after the conversion on the basis of, for example, a dictionary stored in the storing section 120 (step S61). In step S61, the control section 140 generates a text after the translation, temporarily stores the text in the storing section 120 or the like, and generates sound data for reading the text after the translation.

The control section 140 composes an image to be displayed over the sound source of the target sound (step S62). The control section 140 extracts an image of the sound source of the target sound from the picked-up image data of the right camera 61 and the left camera 62, detects an image of the mouth of a human from the extracted image, and processes the detected image of the mouth according to the voice after the translation to compose the image for superimposed display. The image to be composed may be an image of only the mouth or may be an image of the entire face of a talker (a human) who is the sound source of the target sound. In step S62, the control section 140 may read out an image for the superimposed display stored in the storing section 120 in advance. The image stored in the storing section 120 may be an image that can be directly used for the superimposed display. Alternatively, in step S62, the control section 140 may compose the image for the superimposed display by performing composition or editing processing using the read-out image.

The control section 140 outputs voice for reading the text after the translation translated in step S61 from the right earphone 32 and the left earphone 34 and, at the same time, causes the image display section 20 to display the image composed in step S62 (step S63). A display position of the image is adjusted according to the position of the mouth detected in step S62.

Consequently, the user hears the voice obtained by translating the voice uttered by the person set as the target object (the sound source) located in the gazing direction and views the image of the mouth uttering the translated voice. Therefore, the user can accurately sense and recognize the voice after the translation.

The fourth processing shown in FIG. 8 includes the processing for the image displayed by the image display section 20 and is equivalent to the output control processing according to the invention.

### Explanation of Fifth Processing (Processing Corresponding to the Haas Effect)

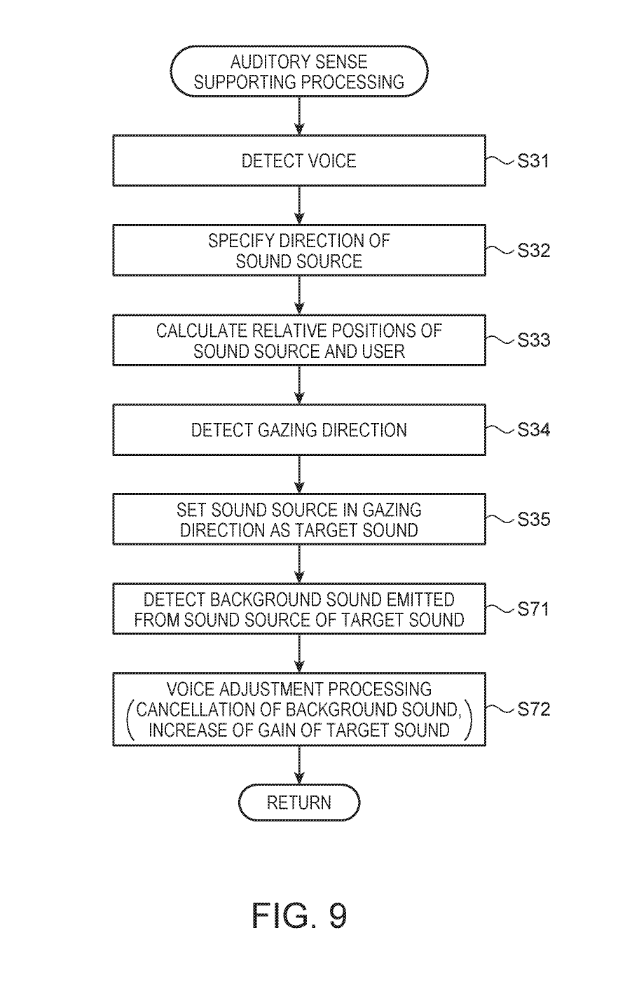

FIG. 9 is a flowchart for explaining the operation of the HMD 100. An operation example is shown in which the control section 140 performs, as the auditory sense supporting processing, fifth processing corresponding to the Haas effect.

The Haas effect is an effect concerning the auditory sense of a human. The Haas effect refers to a phenomenon in which, when the same sounds reach an auditory organ at the same volume or similar volumes from a plurality of different directions, localization is sensed in a sound source direction of sound reaching the auditory organ first. For the user, a situation in which the same sounds are heard from a plurality of directions and a difference occurs in timings when the sounds reach the ears could occur because of, for example, the influence of reflection of the sounds. Therefore, for example, sound emitted by one sound source is sensed as if, because of the influence of reflected sound, the sound is heard from a direction different from a direction in which the sound source is actually located.

The fifth processing shown in FIG. 9 is executed when the control section 140 acquires voice collected by the microphone 63 and outputs, from the right earphone 32 and the left earphone 34, the collected voice or voice generated by applying processing to the collected voice. Therefore, the fifth processing is applied when the control section 140 outputs, as voice related to the AR display, the voice collected by the microphone 63 or voice based on the collected voice in step S14 in FIG. 4.

Steps S31 to S35 in FIG. 9 are processing same as the processing explained with reference to FIG. 5. Therefore, the same step numbers are attached to the steps and explanation of the steps is omitted.

The control section 140 detects, from the background sound, sound same as the sound emitted by the sound source set as the sound source of the processing target sound in step S35 (step S71). In step S35, the sound source in the gazing direction of the user is set as the sound source of the target sound. Therefore, voice collected by the microphone 63 from a direction different from the direction of the sound source is set as the background sound. When sound same as the sound of the sound source is included in the background sound, the control section 140 detects the sound from the background sound.

The control section 140 executes, on the voice collected by the microphone 63, voice adjustment processing for improving the audibility of the target sound set in step S35 (step S72). In the voice adjustment processing in step S72, the control section 140 performs processing for reducing the audibility of the sound detected in step S71. For example, the control section 140 generates sound having a waveform and a phase for cancelling or attenuating the sound detected in step S71 and combines the generated sound with the voice collected by the microphone 63. The control section 140 performs processing for increasing the volume of the target sound set in step S35.

According to the processing shown in FIG. 9, when voice reaching the image display section 20 from the gazing direction of the user also reaches from another direction, it is possible to cause the user to sense localization in the gazing direction and allow the user to more easily hear the voice.

Note that, the processing shown in FIG. 9 is not limited to human voice. Sound that is not the human voice can be set as the target sound. In step S72, a specific method of cancelling a part of the background sound is optional. For example, when it is possible to distinguish and extract the background sound and the voice reaching from the sound source of the target sound, filtering for attenuating the frequency of the target sound may be performed in the background sound.

When the fifth processing shown in FIG. 9 does not include the processing for the image displayed by the image display section 20, the fifth processing corresponds to the output control processing including the sound processing according to the invention. It is also possible to execute the processing shown in FIG. 9 together with the processing for changing the image displayed by the image display section 20. For example, a text, an image, or the like may be displayed by the image display section 20 to improve the visibility of the sound source set in step S35. When the voice adjustment processing is performed in step S72, a text, an image, or the like concerning content of the voice adjustment processing may be displayed.

A plurality of kinds of processing among the kinds of processing shown in FIG. 5 (the first processing), FIG. 6 (the second processing), FIG. 7 (the third processing), FIG. 8 (the fourth processing), and FIG. 9 (the fifth processing) may be combined and executed as the auditory sense supporting processing in step S15 in FIG. 4. Any one kind of processing may be selected and executed. The auditory sense supporting processing may be selected according to content of the AR processing executed in step S14. The auditory sense supporting processing may be selected according to input operation of the user on the control device 10 or prior setting. For example, when a plurality of voices are included in the voice collected by the microphone 63, the first processing shown in FIG. 5 or the second processing shown in FIG. 6 may be selected. When it is determined that the sound source of the target sound is moving, the third processing in FIG. 7 may be selected. When translation of the voice is performed, the fourth processing shown in FIG. 8 may be selected. When the voice of the target sound is collected and detected as a plurality of voices because of reflection or the like, the fifth processing shown in FIG. 9 may be selected. That is, the HMD 100 may automatically select and execute processing on the basis of the processing executed in step S14 (FIG. 4) and content of the voice collected by the microphone 63.

As explained above, the HMD 100 according to the embodiment applied with the invention includes the image display section 20 that causes the user to visually recognize an image and transmits an outside scene and the right earphone 32 and the left earphone 34 that output voice. The HMD 100 includes the AR control section 185 that executes the voice output processing (the sound output processing) for causing the right earphone 32 and the left earphone 34 to output voice and the output control processing including the voice processing (the sound processing) for the voice output by the right earphone 32 and the left earphone 34 or the processing for the image displayed by the image display section 20, the output control processing changing the audibility of the voice output by the right earphone 32 and the left earphone 34. Therefore, in the HMD 100, by changing the audibility of the output voice, it is possible to improve the audibility without blocking factors of deterioration in the audibility such as environmental sound on the outside. Consequently, it is possible to achieve improvement of a visual effect and an audio effect without spoiling convenience. Specifically, the AR control section 185 executes, in step S14, the voice output processing for causing the right earphone 32 and the left earphone 34 to output voice and executes, as the output control processing including the sound processing, at least any one of the first processing shown in FIG. 5, the third processing shown in FIG. 7, and the fifth processing shown in FIG. 9. The AR control section 185 may execute any one of the first processing shown in FIG. 5, the third processing shown in FIG. 7, and the fifth processing shown in FIG. 9 and the processing of the image displayed by the image display section 20 in combination. Alternatively, as the output control processing including the processing for the image displayed by the image display section 20, the AR control section 185 executes the second processing shown in FIG. 6 and/or the fourth processing shown in FIG. 8.

In the voice output processing, the HMD 100 may cause the right earphone 32 and the left earphone 34 to output voice corresponding to the image displayed by the image display section 20. For example, when causing the image display section 20 to display an AR image and causing the right earphone 32 and the left earphone 34 to output voice related to or associated with the AR image, the control section 140 may execute the auditory sense supporting processing as the output control processing.

In the voice output processing, the control section 140 may output voice not corresponding to the image displayed by the image display section 20. For example, when executing a first application program for displaying the AR image and a second application program for outputting voice, the control section 140 can execute voice processing concerning voice output by the second application program or voice collected by the microphone 63. In this case, the AR image displayed by the first application program and the operation of the second application program do not need to be associated. The first and second application programs may be executed independently from each other. The first and second application programs may be associated. For example, the second application program may output voice related to the AR image displayed by the first application program. Examples of the second application program include a navigation program for detecting the position of the HMD 100 with the GPS 115 and outputting voice on the basis of the detected position (coordinate) and a music reproducing program. The second application program may be a broadcast receiving program for receiving a radio broadcast, a television broadcast, an Internet broadcast, and the like and outputting voice.

The HMD 100 includes the motion detecting section 181 that detects at least any one of the position, the movement, and the direction of the head of the user. The AR control section 185 executes the output control processing on the basis of a result of the detection of the motion detecting section 181. Therefore, it is possible to improve, according to the position and the movement of the head of the user, the audibility of voice output by the HMD 100. It is possible to achieve further improvement of the auditory effect.

The HMD 100 includes the nine-axis sensor 66. The motion detecting section 181 calculates at least any one of the position, the movement, and the direction of the head of the user on the basis of a detection value of the nine-axis sensor 66.

The AR control section 185 executes, for example, in step S32, the sound specifying processing for specifying external sound and the position of a sound source of the external sound and executes the output control processing on the basis of the specified external sound or the specified position of the sound source. Consequently, by performing processing on the basis of the position of a sound source of voice emitted from the outside, it is possible to improve the audibility of voice output by the HMD 100.

The HMD 100 includes the microphone 63 that collects and detects external sound. The AR control section 185 executes the sound specifying processing on the basis of sound detected from the gazing direction of the user by the microphone 63 and a result of the detection of the motion detecting section 181 and specifies external sound and the position of a sound source that emits the external sound. Therefore, it is possible to easily detect the external sound and the position of the sound source of the external sound.

In the output control processing, the AR control section 185 causes the right earphone 32 and the left earphone 34 to output voice based on external voice detected by the microphone 63. Therefore, it is possible to prevent deterioration in the audibility of voice output by the HMD 100 due to the influence of the external voice.

The AR control section 185 calculates relative positions of the position of the head of the user detected by the motion detecting section 181 and the position of the sound source specified by the sound specifying processing and executes the output control processing on the basis of the calculated relative positions. Therefore, it is possible to surely improve, according to the position of the head of the user and the position of the sound source, the audibility of voice output by the HMD 100.

The AR control section 185 calculates relative positions of the position of the sound source specified by the sound specifying processing and the position of each of the eyes and the ears of the user in addition to the relative positions of the position of the head of the user and the position of the sound source. Therefore, it is possible to more surely improve the audibility of voice output by the HMD 100.

For example, in the third processing shown in FIG. 7, the AR control section 185 generates auditory sense information related to the auditory sense of the user on the basis of the relative positions of the position of the head of the user and the position of the sound source, executes the output control processing on the basis of the auditory sense information, and updates the auditory sense information on the basis of the movement of the head of the user detected by the motion detecting section 181. Therefore, it is possible to perform processing appropriately reflecting the relative positions of the head of the user and the sound source.

The HMD 100 includes the visual-line detecting section 183 that detects a visual line direction of the user. The AR control section 185 specifies a gazing direction of the user from a result of the detection of the visual-line detecting section 183 and executes the output control processing according to the specified direction. Therefore, it is possible to detect the gazing direction of the user and further improve the visual effect and the audio effect.

For example, in the second processing shown in FIG. 6, the AR control section 185 detects a gazing direction of the user or a target object gazed by the user and causes the image display section 20 to perform display for improving the visibility in the detected gazing direction or the visibility of the detected target object. Therefore, by improving the visibility in the gazing direction of the user to thereby call more strong attention to the gazing direction, it is possible to expect an effect of improving the audibility of sound heard from the gazing direction. Therefore, it is possible to improve, making use of a so-called cocktail party effect, the audibility of sound that the user desires to hear.

For example, in the first processing shown in FIG. 5, the AR control section 185 detects a gazing direction of the user and a target object gazed by the user, selects voice reaching from the detected gazing direction or the direction of the detected target object, and improves acoustic processing for improving the audibility of the selected voice. Consequently, in the HMD 100 that displays an image and outputs voice corresponding to the image, by changing the audibility of the output sound, it is possible to improve the audibility without blocking factors of deterioration in the audibility such as environmental sound on the outside. Consequently, it is possible to achieve improvement of the visual effect and the audio effect without spoiling convenience.

For example, in the fourth processing shown in FIG. 8, the AR control section 185 executes the translation processing for recognizing voice collected by the microphone 63 as a language and translating the voice and the translated voice output processing for causing the right earphone 32 and the left earphone 34 to output the voice after the translation. When performing the translated voice output processing, the AR control section 185 causes the image display section 20 to display an image corresponding to the voice after the translation. Therefore, in the HMD 100, it is possible to collect and translate voice, output the voice after the translation, and prevent a situation in which it is hard to identify the voice after the translation because of visual information. Therefore, it is possible to improve the audibility of the voice after the translation.

Note that the invention is not limited to the configuration of the embodiment explained above and can be carried out in various forms within a range not departing from the spirit of the invention.

For example, in the embodiment, an image display section of another system such as an image display section worn like a cap may be adopted instead of the image display section 20. The image display section only has to include a display section that displays an image to correspond to the left eye of the user and a display section that displays an image to correspond to the right eye of the user. The display device according to the invention may be configured as, for example, a head mounted display mounted on a vehicle such as an automobile or an airplane. The display device may be configured as, for example, a head mounted display incorporated in a body protector such as a helmet. The display device may be a head-up display (HUD) used in a windshield of an automobile.

As explained above, the sound output by the HMD 100, the sound collected and processed by the microphone 63, and the sound processed by the voice processing section 187 are not limited to voice uttered by a human or voice similar to the human voice and only have to be sound such as natural sound and artificial sound. As an example, “voice” written in this embodiment includes the human voice. However, this is only an example and does not limit an application range of the invention to the human voice. For example, the AR control section 185 and the voice processing section 187 may be configured to determine whether voice collected by the microphone 63 or voice output from the right earphone 32 and the left earphone 34 is voice recognizable as a language. Frequency bands of the sound output by the right earphone 32 and the left earphone 34, the sound collected by the microphone 63, and the sound processed by the voice processing section 187 are not particularly limited either. The frequency bands of the sound output by the right earphone 32 and the left earphone 34, the sound collected by the microphone 63, and the sound processed by the voice processing section 187 may be different from one another. The right earphone 32 and the left earphone 34, the microphone 63, and the voice processing section 187 may process sound in the same frequency band. An example of the frequency band may be sound audible by the user, that is, sound in an audible frequency band of the human or may include sound having a frequency outside the audible frequency band. Further, a sampling frequency and the number of quantizing bits of sound data processed in the HMD 100 are not limited either.

Further, in the embodiment, the configuration in which the image display section 20 and the control device 10 are separated and connected via the connecting section 40 is explained as an example. However, it is also possible to adopt a configuration in which the control device 10 and the image display section 20 are integrated and worn on the head of the user.

For example, as a component that generates image light in the image display section 20, the image display section 20 may include an organic EL (electro-luminescence) display and an organic EL control section. As the component that generates image light, an LCOS (Liquid crystal on silicon; LCoS is a registered trademark), a digital micro mirror device, and the like can also be used. For example, the invention can also be applied to a head mounted display of a laser retinal projection type. That is, a configuration may be adopted in which the image generating section includes a laser beam source and an optical system for guiding a laser beam to the eyes of the user, makes the laser beam incident on the eyes of the user to scan the retina, and forms an image on the retina to thereby cause the user to visually recognize the image. When the head mounted display of the laser retinal projection type is adopted, “a region where image light can be emitted in the image-light generating section” can be defined as an image region recognized by the eyes of the user.

As an optical system that guides the image light to the eyes of the user, a component can be adopted that includes an optical member for transmitting external light made incident on the device from the outside and makes the external light incident on the eyes of the user together with the image light. An optical member located in front of the eyes of the user and overlapping a part or the entire visual field of the user may be used. Further, an optical system of a scanning type that scans a laser beam or the like and changes the laser beam to image light may be adopted. The optical system is not limited to an optical system that guides the image light inside the optical member and may be an optical system including only a function of refracting and/or reflecting the image light to guide the image light to the eyes of the user.

The invention can also be applied to a display device that adopts a scanning optical system including a MEMS mirror and makes use of a MEMS display technique. That is, the display device may include, as an image display element, a signal-light forming section, a scanning optical system including a MEMS mirror that scans light emitted by the signal-light forming section, and an optical member on which a virtual image is formed by the light scanned by the scanning optical system. In this configuration, the light emitted by the signal-light forming section is reflected by the MEMS mirror, made incident on the optical member, and guided in the optical member to reach a virtual-image forming surface. The MEMS mirror scans the light, whereby a virtual image is formed on the virtual image forming surface. The user catches the virtual image with the eyes to recognize an image. An optical component in this case may be an optical component that guides light through a plurality of times of reflection like, for example, the right light guide plate 261 and the left light guide plate 262 in the embodiment. A half mirror surface may be used as the optical component.

The display device according to the invention is not limited to the display device of the head mounted type. The invention can be applied to various display devices such as a flat panel display and a projector. The display device according to the invention only has to be a display device that causes a user to visually recognize an image using image light together with external light. Examples of the display device include a display device that causes a user to visually recognize an image formed by image light using an optical member that transmits external light. Specifically, besides the display device including the optical member that transmits external light in the head mounted display explained above, the invention can also be applied to a display device that projects image light on a light transmissive plane or curved surface (glass, transparent plastics, etc.) fixedly or movably set in a position apart from a user. Examples of the display device include a display device that projects image light on window glass of a vehicle and causes a user riding on the vehicle or a user present outside the vehicle to visually recognize scenes inside and outside the vehicle together with an image formed by the image light. Further, examples of the display device include a display device that projects image light on a transparent, semitransparent, or colored transparent display surface fixedly set on window glass of a building and causes a user present around the display surface to visually recognize a scene through the display surface together with an image formed by the image light.

In the embodiment, the configuration including the image display section 20 through which an outside scene can be visually recognized is illustrated. However, the invention is not limited to this. The invention can also be applied to a virtual image display device of a non-transmission type with which an outside world cannot be observed and a virtual image display device of a video see-through type that displays a picked-up image picked up by an image pickup device that picks up an image of an outside world. For example, the invention may be applied to a display device that performs, on a picked-up image, editing processing such as processing for combining an image generated on the basis of the picked-up image and other images and displays an edited image to perform MR (Mixed Reality) display.

At least a part of the functional blocks shown in FIG. 3 may be realized by hardware or may be realized by cooperation of the hardware and software. The invention is not limited to the configuration in which the independent hardware resources are disposed as shown in FIG. 3. The computer program executed by the control section 140 may be stored in the storing section 120 or a storage device in the control device 10. The control section 140 may be configured to acquire the computer program stored in an external device via the communication section 117 or the interface 125 and execute the computer program.

The functions of the computer program executed by the control section 140, that is, the processing sections (e.g., the image processing section 160, the display control section 170, the motion detecting section 181, the visual-line detecting section 183, the AR control section 185, the voice processing section 187, and other generating sections, determining sections, specifying sections, and the like) included in the control section 140 may be configured using an ASIC (Application Specific Integrated Circuit) or an SoC (System on a Chip) designed to realize the functions. The processing sections may also be realized by a programmable device such as an FPGA (Field-Programmable Gate Array).

Among the components formed in the control device 10, only the operation section 111 may be formed as an independent user interface (UI). The components formed in the control device 10 may be redundantly formed in the image display section 20. For example, the control section 140 shown in FIG. 3 may be formed in both of the control device 10 and the image display section 20. The functions performed by the control section 140 formed in the control device 10 and the CPU formed in the image display section 20 may be separated.

The entire disclosure of Japanese Patent Application No. 2015-089327, filed Apr. 24, 2015 is expressly incorporated by reference herein.

What is claimed is:

1. A display device mounted on a head of a user, the display device comprising:
a display section configured to display an image;
a sound output section configured to output sound; and
a processing section configured to execute sound output processing for causing the sound output section to output sound and output control processing including sound processing for the sound output by the sound output section or processing for the image displayed by the display section, the output control processing changing audibility of the sound output by the sound output section.

2. The display device according to claim 1, wherein, in the sound output processing, the processing section causes the sound output section to output sound corresponding to the image displayed by the display section.

3. The display device according to claim 1, further comprising a motion detecting section configured to detect at least any one of a position, a movement, and a direction of the head of the user, wherein
the processing section executes the output control processing on the basis of a result of the detection of the motion detecting section.

4. The display device according to claim 3, further comprising a movement sensor configured to detect the movement of the head of the user, wherein
the motion detecting section calculates at least one of the position, the movement, and the direction of the head of the user on the basis of a detection value of the movement sensor.

5. The display device according to claim 3, wherein the processing section performs sound specifying processing for specifying external sound and a position of a sound source of the external sound and executes the output control processing on the basis of the specified external sound or the specified position of the sound source.

6. The display device according to claim 5, further comprising a microphone configured to collect and detect the external sound, wherein
the processing section executes the sound specifying processing on the basis of sound detected from a gazing direction of the user by the microphone and the detection result of the motion detecting section and specifies the external sound and the position of the sound source that emits the external sound.

7. The display device according to claim 6, wherein, in the output control processing, the processing section causes the sound output section to output sound based on the external sound detected by the microphone.

8. The display device according to claim 5, wherein the processing section calculates relative positions of the position of the head of the user detected by the motion detecting section and the position of the sound source specified by the sound specifying section and executes the output control processing on the basis of the calculated relative positions.

9. The display device according to claim 8, wherein the processing section calculates relative positions of the position of the sound source specified by the sound specifying processing and each of the eyes and the ears of the user in addition to the relative positions of the position of the head of the user and the position of the sound source.

10. The display device according to claim 5, wherein the processing section generates auditory sense information related to auditory sensation of the user on the basis of the relative positions of the position of the head of the user and the position of the sound source, executes the output control processing on the basis of the auditory sense information, and updates the auditory sense information on the basis of the movement of the head of the user detected by the motion detecting section.

11. The display device according to claim 5, wherein, in the output control processing, the processing section perform processing for the image displayed by the display section to change visibility of the user in viewing a direction corresponding to the position of the sound source.

12. The display device according to claim 1, further comprising a visual-line detecting section configured to detect a visual line direction of the user, wherein
the processing section specifies a gazing direction of the user from a result the detection of the visual-line detecting section and executes the output control processing according to the specified direction.

13. The display device according to claim 12, wherein, in the output control processing, the processing section displays the image over a target object located in the gazing direction of the user.

14. A control method for a display device comprising:
controlling a display device worn on a head of a user and including a display section configured to display an image and a sound output section configured to output sound;
causing the sound output section to output sound; and
executing output control processing including sound processing for the sound output by the sound output section or processing for the image displayed by the display section, the output control processing changing audibility of the sound output by the sound output section.

15. A computer program executable by a computer that controls a display device worn on a head of a user and including a display section configured to display an image and a sound output section configured to output sound,
the computer program causing the computer to function as a processing section configured to execute sound output processing for causing the sound output section to output sound and output control processing including sound processing for the sound output by the sound output section or processing for the image displayed by the display section, the output control processing changing audibility of the sound output by the sound output section.
